(19) United States
(12) Patent Application Publication
(10) Pub. No.: US 2004/0016142 A1
(43) Pub. Date: Jan. 29, 2004

(54) Apparatus and method for measuring distances on a surface according to a designated scale

(76) Inventor: Bernard Arthur Beber, Miami, FL (US)

Correspondence Address: LAW OFFICE OF DONALD D. MONDUL, 6631 LOVINGTON DRIVE, DALLAS, TX, 75252, US

(21) Appl. No.: 10/201,672

(22) Filed: Jul. 23, 2002

(51) Int. Cl. G01B 5/00

(52) U.S. Cl. 33/783; 33/558.01

(57) ABSTRACT

An apparatus for measuring distances on a surface according to a designated scale includes: (a) a distance indicating unit for indicating distance between a first locus and a second locus on the surface; (b) a calibration unit coupled with the distance indicating unit for effecting calibration of the apparatus to the designated scale; (c) a control unit for controlling at least the calibration; the control unit being coupled with at least the calibration unit; and (d) a display unit for displaying information relating at least to the calibration and the distance; the display unit being coupled at least with the control unit. At least the control unit, the distance indicating unit and the display unit cooperate to indicate the distance according to the designated scale after the calibration.

### BACKGROUND OF THE INVENTION

The present invention is directed to an apparatus and method for measuring distances on objects, and especially to an apparatus and method for measuring distances on plane surfaces.

Certain images requiring measurement of distances thereon are produced primarily to present an advantageous rendering of the image, rather than adhering to a particular scale in representing distances in the image. Examples of such imagery include aerial survey photographs and maps. One type of image in which the variance among images is also common is medical imagery, such as computer generated CT (computed tomography) and MRI (magnetic resonance imagery) images. Such medical images are not printed according to a single scale of measurement. The scale of measurement often is different from one image to another, even in images relating to the same patient in a single imaging visit.

An indication scale of measurement, such as a set of hash marks, is commonly provided in a margin of such a medical image. However, imaging machinery operators typically strive to obtain the best magnification and framing of the area of interest to an image examiner, such as a doctor, in making their magnification and other settings during imaging procedures. Consequently, the scale of measurement changes from one image to another making it very difficult to measure distances in various images without constant recalculation of the scale or scales involved. No device exists that can simply accommodate application of various scales of measurement, thereby facilitating accurate measurement of objects in images, such as medical images.

As mentioned, hash marks or similar indicia are commonly provided in the margin of a medical image to establish the scale of the particular image. However, magnification and other settings are usually changed by an operator to achieve the best image available for review. This changing of settings means that the scale cannot be relied upon directly. The scale indicia (e.g., hash marks) in the margin are provided by the imaging machine, and are magnified or otherwise manipulated as the image is manipulated during imaging operations. Thus, the scale indicia are true with respect to the image, but the scale indicia likely are not true with respect to a commonly recognized scalar measure, such as centimeters, inches or similar measurement units. Such a variance of scale of an image with respect to a common scalar measure is troublesome when dealing with a single image. The variance becomes truly vexing when dealing with a plurality of images, each of which has a different random scaling.

While the length of an object in an image may be measured very accurately according to scale on a computer (i.e., before the image is printed) it is unusual that an examiner of the image will be present while the image is being generated by the computer. Consequently, the accuracy of measurement provided by the image generating machinery is not often available to the examiner (i.e., doctor) who needs to view the image.

Scaling indicia are commonly used by those viewing the images by employing calipers or similar distance measuring devices to measure a desired dimension in the image, and then holding the calipers against the scale indicia in the margin of the image to determine the measured length according to the provided scale. As an alternative, the hash marks or other indicia are copied by hand on a piece of paper and the paper is held up adjacent to the object in the image to be measured in order to effect the desired measurement. As mentioned, since the scale of measurement in computer-generated medical images (and other computer generated images), the scale of an image often varies from image to image. There is no single device which can be used to accurately effect measurements in images from different studies with differing scales of measurement. As a consequence, an examiner of images must create his own crude ruler (e.g., paper template). Such ad hoc solutions are inefficient, are susceptible to human or other errors and can be inaccurate.

There is a need for an apparatus and method for measuring dimensions of variously scaled objects that can directly calibrate to a particular relevant scale for an image.

There is also a need for an apparatus and method for measuring dimensions of variously scaled objects that is easy and efficient to use.

There is a further need for an apparatus and method for measuring dimensions of variously scaled objects that is reduces human error and provides accurate measurements.

### SUMMARY OF THE INVENTION

An apparatus for measuring distances on a surface according to a designated scale includes: (a) a distance indicating unit for indicating distance between a first locus and a second locus on the surface; (b) a calibration unit coupled with the distance indicating unit for effecting calibration of the apparatus to the designated scale; (c) a control unit for controlling at least the calibration; the control unit being coupled with at least the calibration unit; and (d) a display unit for displaying information relating at least to the calibration and the distance; the display unit being coupled at least with the control unit. At least the control unit, the distance indicating unit and the display unit cooperate to indicate the distance according to the designated scale after the calibration.

A method for measuring distances on a surface according to a designated scale includes steps of: (a) in no particular order: (1) providing a distance indicating unit for indicating distance between a first locus and a second locus on the surface; (2) providing a calibration unit for effecting calibration of the apparatus to the designated scale; and (3) providing a display unit for displaying information relating at least to the calibration and the distance; (b) establishing a calibration distance with the first locus and the second locus on the designated scale for calibration to the designated scale; (c) calibrating at least one of the distance indicating unit and the display unit to the designated scale; and (d) operating the calibration unit, the display unit and the distance measuring unit cooperatively for subsequent measurements to indicate the distance between the first locus and the second locus according to the designated scale.

It is, therefore, an object of the present invention to provide an apparatus and method for measuring dimensions of variously scaled objects that can directly calibrate to a particular relevant scale for an image.

It is a further object of the present invention to provide an apparatus and method for measuring dimensions of variously scaled objects that is easy and efficient to use.

It is still a further object of the present invention to provide an apparatus and method for measuring dimensions of variously scaled objects that is reduces human error and provides accurate measurements

Further objects and features of the present invention will be apparent from the following specification and claims when considered in connection with the accompanying drawings, in which like elements are labeled using like reference numerals in the various figures, illustrating the preferred embodiments of the invention.

### BRIEF DESCRIPTION OF THE DRAWINGS

FIG. 1 is a plan schematic view of a representative surface on which measurements are to be performed, embodied in a medical image medium.

FIG. 2 is a schematic illustration of a first embodiment of the present invention.

FIG. 3 is a schematic illustration of a second embodiment of the present invention.

FIG. 4 is a flow diagram illustrating the method of the present invention.

### DETAILED DESCRIPTION OF THE PREFERRED EMBODIMENT

In its preferred embodiment, the invention is a measuring device using laser dimensioning between two measuring indicators, such as a caliper device or a compass device. Other measuring technologies may be employed to determine displacement between measuring indicators, such as echo ranging, mechanical angular measurement, or other approaches. The preferred embodiment of the invention includes a display, such as an LCD (liquid crystal diode) display that can electronically be adjusted to a user-defined scale of measurement based upon the scale indicia provided with the image. Such scale indicia may include, by way of example and not by way of limitation, hash marks in the margin of a medical image, or scale legends of other sorts provided with aerial photographs or maps. In using the apparatus, a user may effect calibration to the desired scale indicia by placing one measuring indicator at a “zero” hash mark of the provided scale indicia, and then placing a second measuring indicator at another hash mark.

The apparatus may be predisposed, or preprogrammed, to consider that the second measuring indicator is displaced a predetermined number of measuring units (e.g., 10 units) for calibration. In the alternative, a user may designate how many hash marks are involved in the calibration step. There may also be provision for the user to designate the units of measure (e.g., centimeters, inches, feet, miles, fathoms or another unit of measure) for the calibration step.

The preferred embodiment of the apparatus of the invention includes a control section that has a computing capability, such as a microprocessor, and an input device, such as a keypad, handwriting recognition capability or voice recognition input.

Once the measuring indicators are placed on the scale indicia for effecting calibration of the apparatus, a user may indicate that event, as for example by pressing a “SET” button or by another input (e.g., by a keypad entry or a voice command). In such manner, the scale of measurement is calibrated to the apparatus. Post-calibration measurements are carried out according to the calibrated scale. Thus, after the apparatus is calibrated to a designated scale, a user may set the measuring indicators to mark the boundaries of the length to be measured, and the apparatus will evaluate the distance between the measuring indicators according to the calibrated scale. The distance between the measuring indicators will be indicated on a display in terms of the calibrated scale.

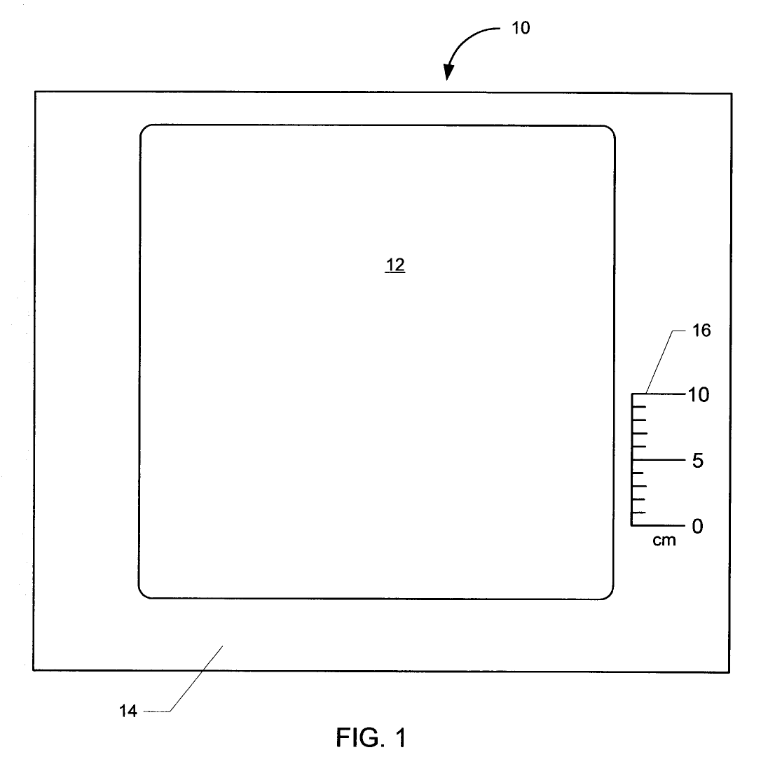

FIG. 1 is a plan schematic view of a representative surface on which measurements are to be performed, embodied in a medical image medium. In FIG. 1, a medical image medium 10 includes an image field 12 containing a medical image (not shown in detail in FIG. 1) such as a CT (computed tomography) or MRI (magnetic resonance imagery) scan image. Surrounding image field 12 is a margin 14. Scale indicia 16 are provided in margin 14 for use in measuring images in image field 12. During its creation and printing, image medium 10 may have been enlarged or reduced and may have been cropped in order to present the best image possible in image field 12. Consequently, even though scale indicia 16 indicates that the scale is in centimeters (see “cm” adjacent to scale indicia 16), the scale is only truly in centimeters as it applies to image filed 12. That is, scale indicia 16 has been enlarged, reduced, cropped or otherwise “manipulated” similarly to image filed 12. Thus, one cannot accurately measure distances in image field 12 using an independently produced centimeter scale because such an independently produced centimeter scale has not undergone the same “manipulations” as image field 12. The only centimeter scale truly applicable to image field 12 is the scale that has been “manipulated” similarly with image field 12. That is, scale indicia 16.

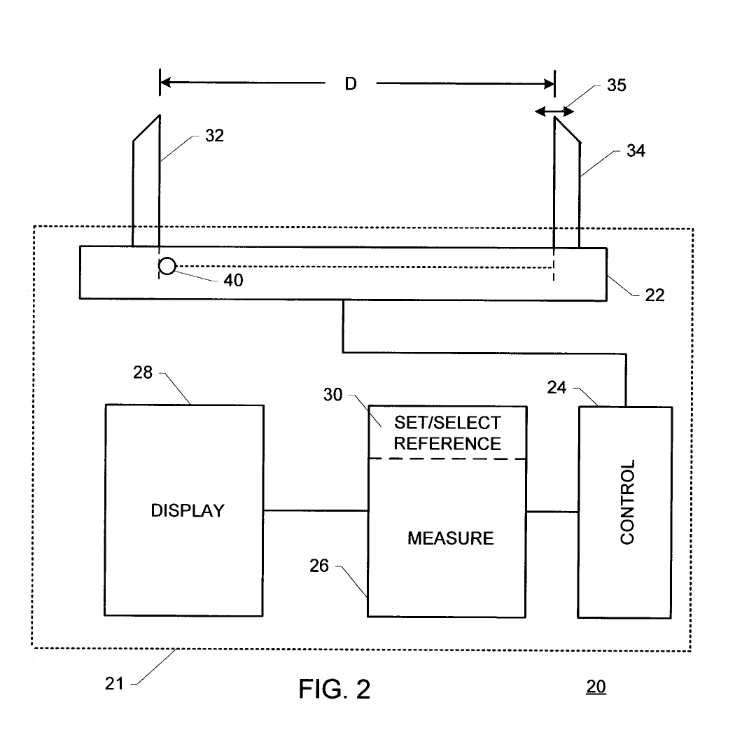

FIG. 2 is a schematic illustration of a first embodiment of the present invention. In FIG. 2, a measuring apparatus 20 includes a distance or span indicating unit 22, a control unit 24, a measurement unit 26 and a display unit 28. Measurement unit 26 may include a reference setting and selecting (or calibration) unit 30, or calibration unit 30 may be a separate unit. All of span indicating unit 22, control unit 24, measurement unit 26, display unit 28 and calibration unit 30 are coupled, either with each other or through each other, to carry out calibration and measuring operations as described above in connection with the preferred embodiment of the apparatus of the invention.

Control unit 24 includes a control section that has a computing capability, such as a microprocessor, and an input device, such as a keypad, handwriting recognition capability or voice recognition input (not shown in detail in FIG. 2).

Span indicating unit 22 includes locator members 32, 34 for locating first and second loci (not shown in FIG. 2) between which a span, or distance D is to be measured. At least one of locator members 32, 34 is movable to adjust distance D. In the preferred embodiment of measuring apparatus 20, only one locator member, such as locator member 34 is movable (as indicated by two-way arrow 35); locator member 32 is preferably fixed. In the preferred embodiment of measuring apparatus 20, distance D between locator members 32, 34 is measured using a light source 40, preferably embodied in a laser light source. Light source 40 may be reflected from locator member 34 and in a manner known in the art, distance D between locator members 32, 34 may be ascertained by measuring transit time of a round trip from locator member 32 to locator member 34 and back to locator member 32. Alternatively, light source 40 may be replaced or supplemented by other distance determining arrangements, such as sonar, pulsed light or sound not reflected (timed for a one way trip from locator member 32 to locator member 34), displacement between locator members along an ohmic or resistive trace, or other measurement systems. Measuring system 20 is preferably contained in a housing to form a compact package with a battery (not shown in FIG. 2) convenient for keeping in a user's pocket, as indicated by dotted line 21.

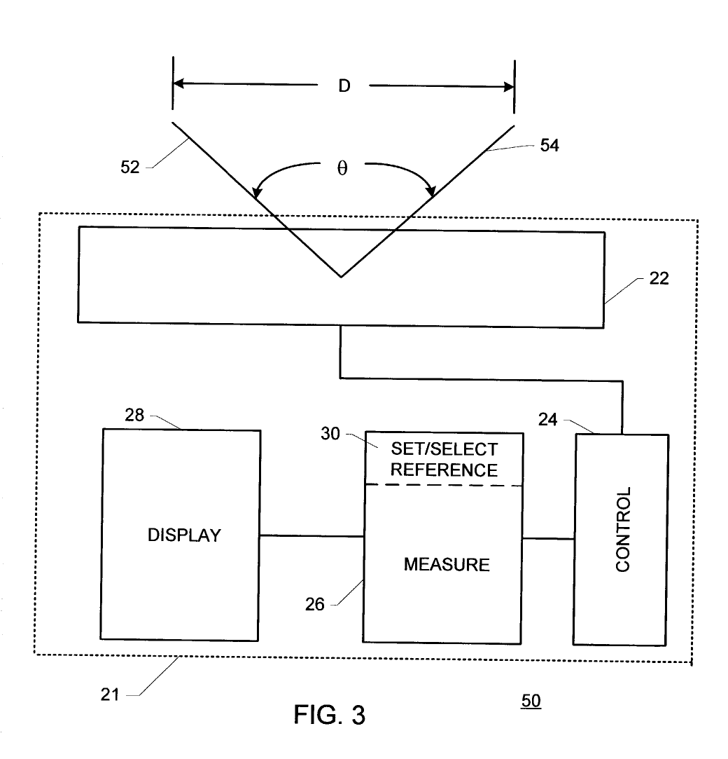

FIG. 3 is a schematic illustration of a second embodiment of the present invention. In FIG. 3, a measuring apparatus 50 is illustrated that is substantially similar to measuring apparatus 20 (FIG. 2). The significant difference between measuring apparatus 20 (FIG. 2) and measuring apparatus 50 is in the configuration of locator members associated with the span or distance indicating unit.

Thus, measuring apparatus 50 includes a distance or span indicating unit 22, a control unit 24, a measurement unit 26 and a display unit 28. Measurement unit 26 may include a reference setting and selecting (or calibration) unit 30, or calibration unit 30 may be a separate unit. All of span indicating unit 22, control unit 24, measurement unit 26, display unit 28 and calibration unit 30 are coupled, either with each other or through each other, to carry out calibration and measuring operations as described above in connection with the preferred embodiment of the apparatus of the invention.

Control unit 24 includes a control section that has a computing capability, such as a microprocessor, and an input device, such as a keypad, handwriting recognition capability or voice recognition input (not shown in detail in FIG. 3).

Span indicating unit 22 includes locator members 52, 54 for locating first and second loci (not shown in FIG. 3) between which a span, or distance D is to be measured. At least one of locator members 52, 54 is movable to adjust angle θ between locator members 52, 54, thus adjusting distance D. Angle θ between locator members 52, 54 may be measured using any manner known in the art including, by way of example and not by way of limitation, laser ranging, sonar, pulsed light or sound not reflected (timed for a one way trip from locator member 52 to locator member 54), or other measurement systems.

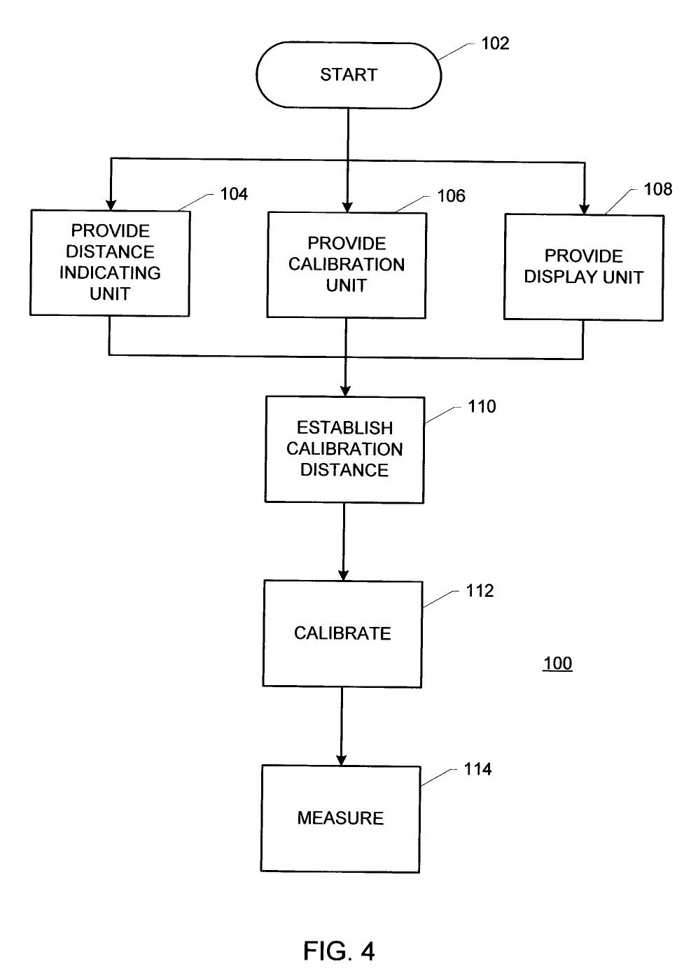

FIG. 4 is a flow diagram illustrating the method of the present invention. In FIG. 4, a method 100 for measuring distances on a surface according to a designated scale begins at a START locus 102. Method 100 proceeds with the step of, in no particular order: (1) providing a distance indicating unit for indicating distance between a first locus and a second locus on the surface (as indicated by a block 104); (2) providing a calibration unit for effecting calibration of the apparatus to the designated scale (as indicated by a block 106); and (3) providing a display unit for displaying information relating at least to the calibration and the distance (as indicated by a block 108).

Method 100 continues by establishing a calibration distance with the first locus and the second locus on the designated scale for calibration to the designated scale, as indicated by a block 110. Method 100 further continues by calibrating at least one of the distance indicating unit and the display unit to the designated scale, as indicated by a block 112. Method 100 continues by operating the calibration unit, the display unit and the distance measuring unit cooperatively for subsequent measurements to indicate the distance between the first locus and the second locus according to the designated scale, as indicated by a block 114.

It is to be understood that, while the detailed drawings and specific examples given describe preferred embodiments of the invention, they are for the purpose of illustration only, that the apparatus and method of the invention are not limited to the precise details and conditions disclosed and that various changes may be made therein without departing from the spirit of the invention which is defined by the following claims:

I claim:

1. An apparatus for measuring dimensions of variously scaled objects; the apparatus comprising:
(a) a span indicating unit; said span indicating unit including a first locator member for locating at a first locus on said object and a second locator unit for locating at a second locus on said object; at least one of said first locator member and said second locator member being movable; said span indicating unit determining separation of said first locator unit and said second locator unit when said first locator unit is at said first locus and said second locator unit is at said second locus; said separation indicating a span between said first locus and said second locus;
(b) a measurement unit coupled with said span indicating unit for measuring said span;
(c) a reference unit coupled with at least one of said span indicating unit and said measurement unit; said reference unit calibrating at least one of said span indicating unit and said measurement unit to a provided scale; and
(d) a display unit coupled with at least one of said span indicating unit, said control unit and said measurement unit; said display unit displaying information relating to at least one of said span and said calibrating.

2. An apparatus for measuring dimensions of variously scaled objects as recited in claim 1 wherein said span indicating unit employs light for determining said separation.

3. An apparatus for measuring dimensions of variously scaled objects as recited in claim 1 wherein said reference unit effects said calibration when said first locus and said second locus are situated at a known said separation according to said provided scale.

4. An apparatus for measuring dimensions of variously scaled objects as recited in claim 1 wherein said reference unit effects said calibration when said first locus and said second locus are situated at a designated said separation according to said provided scale.

5. An apparatus for measuring dimensions of variously scaled objects as recited in claim 4 wherein the apparatus further comprises a control unit coupled with at least one of said reference unit and said measurement unit, and wherein said designated separation is established by said control unit.

6. An apparatus for measuring dimensions of variously scaled objects as recited in claim 2 wherein said reference unit effects said calibration when said first locus and said second locus are situated at a known said separation according to said provided scale.

7. An apparatus for measuring dimensions of variously scaled objects as recited in claim 2 wherein said reference unit effects said calibration when said first locus and said second locus are situated at a designated said separation according to said provided scale.

8. An apparatus for measuring dimensions of variously scaled objects as recited in claim 7 wherein the apparatus further comprises a control unit coupled with at least one of said reference unit and said measurement unit, and wherein said designated separation is established by said control unit.

9. An apparatus for measuring dimensions of variously scaled objects as recited in claim 1 wherein said first locator unit is oriented with respect to a first axis and said second locator unit is oriented with respect to a second axis; said first axis and said second axis intersecting at a point; said span indicating unit employing angular displacement between said first axis and said second axis for determining said separation.

10. An apparatus for measuring dimensions of variously scaled objects as recited in claim 9 wherein said reference unit effects said calibration when said first locus and said second locus are situated at a known said separation according to said provided scale.

11. An apparatus for measuring dimensions of variously scaled objects as recited in claim 9 wherein said reference unit effects said calibration when said first locus and said second locus are situated at a designated said separation according to said provided scale.

12. An apparatus for measuring dimensions of variously scaled objects as recited in claim 11 wherein the apparatus further comprises a control unit coupled with at least one of said reference unit and said measurement unit, and wherein said designated separation is established by said control unit.

13. An apparatus for measuring distances on a surface according to a designated scale; the apparatus comprising:
(a) a distance indicating unit for indicating distance between a first locus and a second locus on said surface;
(b) a calibration unit coupled with said distance indicating unit for effecting calibration of the apparatus to said designated scale;
(c) a control unit for controlling at least said calibration; said control unit being coupled with at least said calibration unit; and
(d) a display unit for displaying information relating at least to said calibration and said distance; said display unit being coupled at least with said control unit;
at least said control unit, said distance indicating unit and said display unit cooperating to indicate said distance according to said designated scale after said calibration.

14. An apparatus for measuring distances on a surface according to a designated scale as recited in claim 13 wherein said distance indicating unit employs light for indicating said distance.

15. An apparatus for measuring distances on a surface according to a designated scale as recited in claim 14 wherein said calibration unit effects said calibration when said distance indicating unit is oriented to indicate distance between a first calibration locus and a second calibration locus; said first calibration locus and said second calibration locus being situated at a known said distance according to said designated scale.

16. An apparatus for measuring distances on a surface according to a designated scale as recited in claim 14 wherein said calibration unit effects said calibration when said distance indicating unit is oriented to indicate distance between a first calibration locus and a second calibration locus; said first calibration locus and said second calibration locus being situated at a designated said distance according to said designated scale.

17. An apparatus for measuring distances on a surface according to a designated scale as recited in claim 16 wherein said designated distance is established by said control unit.

18. A method for measuring distances on a surface according to a designated scale; the method comprising the steps of:
(a) in no particular order:
(1) providing a distance indicating unit for indicating distance between a first locus and a second locus on said surface;
(2) providing a calibration unit for effecting calibration of the apparatus to said designated scale; and
(3) providing a display unit for displaying information relating at least to said calibration and said distance;
(b) establishing a calibration distance with said first locus and said second locus on said designated scale for calibration to said designated scale;
(c) calibrating at least one of said distance indicating unit and said display unit to said designated scale; and
(d) operating said calibration unit, said display unit and said distance measuring unit cooperatively for subsequent measurements to indicate said distance between said first locus and said second locus according to said designated scale.

19. A method for measuring distances on a surface according to a designated scale as recited in claim 18 wherein said calibration distance is a predetermined distance.

20. A method for measuring distances on a surface according to a designated scale as recited in claim 18 wherein said calibration distance is a established during said establishing step.
